(19) United States
(12) Patent Application Publication
(10) Pub. No.: US 2016/0169369 A1
(43) Pub. Date: Jun. 16, 2016

(54) TRANSMISSION OIL COOLER ADAPTER

(71) Applicant: Jose Jesus Torres, Austin, TX (US)

(72) Inventor: Jose Jesus Torres, Austin, TX (US)

(21) Appl. No.: 14/570,856

(22) Filed: Dec. 15, 2014

(51) Int. Cl. F16H 57/04; F16L 25/00

(52) U.S. Cl. CPC F16H 57/0412; F16L 25/0018

(57) ABSTRACT

A transmission oil cooler adapter is configured to mount to a transmission case and direct transmission oil to and from a transmission oil cooler. The transmission oil cooler adapter includes a housing surrounding a body wherein the body further comprises a first side, a second side and a central opening. A first hose barb and a second hose barb are mechanically coupled to the first side. A longitudinal bore is connected to the first hose barb and traveling through the body. A blind bore is connected to the second hose barb connected to the central opening with a transverse bore. A bolt is inserted through the central opening and attaching the housing to the transmission case. The transmission oil travels through the body and into the transmission case then from the transmission case to the transmission oil cooler in order to cool the transmission oil.

### BACKGROUND

The embodiments herein relate generally to improving performance in machines.

A transmission is an assembly of parts including the speed-changing gears and the propeller shaft by which the power is transmitted from an engine to a live axle. The speed-changing gears and propeller shaft need to be lubricated in order to efficiently turn given the substantial amount of energy coming from the engine to move that energy to the live axel. As used in this application “transmission oil” means all varieties of fluids that can be used as lubricants in this regard including automatic transmission fluid (ATF) and gear oil.

In a typical transmission system, transmission oil is pumped with an oil pump through a filter and then through a transmission. For many applications, no cooler is necessary, however, as engine revolutions per minute (RPMs) increase over a sustained period of time, such as if a user is towing or otherwise carrying a heavy load, the transmission oil heats up and is and begins to burn around 200 degrees Fahrenheit. This decreases the amount of oil that can be used to cool the speed-changing gears and propeller shaft as well as having the burned fragments turn to debris that further clogs the entire transmission system.

A supplementary radiator cools the transmission oil in the hydraulic system. However, these radiators are very limited in their ability to dissipate heat due to reliance on engine coolant. This reliance is misplaced since the engine coolant will be warmer when the vehicle is under the variety of loads that require transmission oil to be cooled in the first instance. While air coolers are more effective, prior to embodiments of the disclosed invention there was no universal adapter to connect any air cooler to any hydraulic system. Embodiments of the disclosed invention solve this problem.

### SUMMARY

A transmission oil cooler adapter is configured to mount to a transmission case and direct transmission oil to and from a transmission oil cooler. The transmission oil cooler adapter includes a housing surrounding a body wherein the body further comprises a first side, a second side and a central opening. A first hose barb and a second hose barb are mechanically coupled to the first side. A longitudinal bore is connected to the first hose barb and traveling through the body. A blind bore is connected to the second hose barb connected to the central opening with a transverse bore. A bolt is inserted through the central opening and attaching the housing to the transmission case. The transmission oil travels through the body and into the transmission case then from the transmission case to the transmission oil cooler in order to cool the transmission oil.

In some embodiments, the central opening is lined with a central tube in order to prevent plastic deformation of the transmission oil cooler adapter undergoing vibration.

In some embodiments, a first diameter exists throughout the transverse bore and the blind bore. A second diameter exists throughout the transverse bore. The first diameter is greater than the second diameter. In some embodiments, the first diameter is twice the second diameter. In some embodiments, the first diameter is three times the second diameter.

In some embodiments, the bolt further comprises a bolt head configured to cover the central opening on the first side. The bolt can further comprise a transition section configured to direct transmission oil toward the transmission case. The bolt further comprises a shaft with a threaded section wherein the threaded section is configured to mate with and attach to the transmission case.

### BRIEF DESCRIPTION OF THE FIGURES

The detailed description of some embodiments of the invention is made below with reference to the accompanying figures, wherein like numerals represent corresponding parts of the figures.

FIG. 1 is a front perspective view of the invention.

FIG. 2 is a rear perspective view of the invention.

FIG. 3 is a cross-sectional view taken on line 3-3 of FIG. 1.

FIG. 4 is a cross-sectional view taken on line 4-4 of FIG. 1.

FIG. 5 is a cross-sectional view taken on line 5-5 of FIG. 1.

### DETAILED DESCRIPTION OF CERTAIN EMBODIMENTS

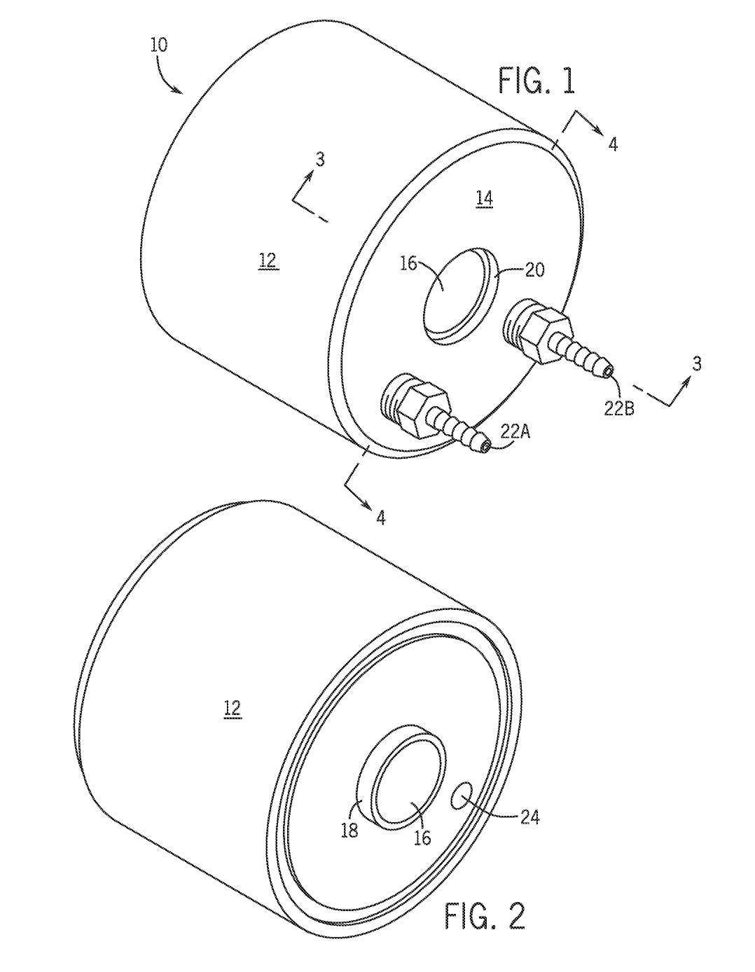

By way of example, and referring to FIG. 1 and FIG. 2, one embodiment of transmission oil cooler adapter 10 comprises housing 12 mechanically coupled to body 14. Housing 12 is in the shape of a cylinder partially filled with body 14 having a modified toroid shape further comprising central opening 16, central opening 16 is partially filled with central tube 18. Central tube 18 extends a small amount from body 14 on a first side, which it is retraced into body 14 on the opposite side forming central bore 20. Central tube 18 is effective at preventing plastic deformation of transmission oil cooler adapter 10 if it undergoes vibration

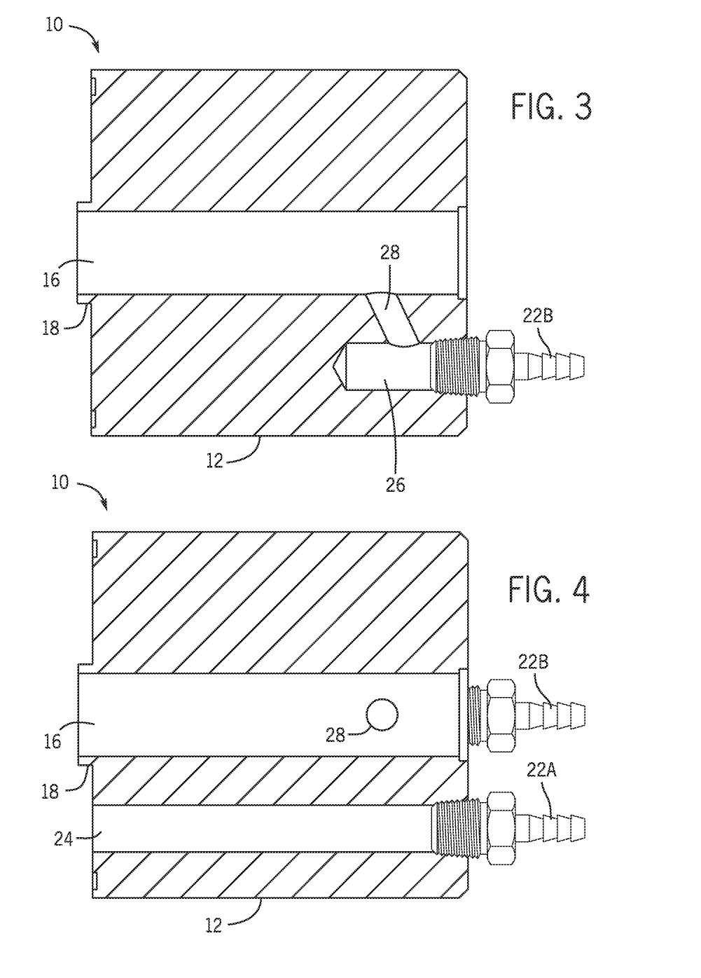

Turning to FIG. 3 and FIG. 4 the first side of body 14 is mechanically coupled to first hose barb 22A and second hose barb 22B. First hose barb 22A is mechanically coupled to longitudinal bore 24, which runs through the length of body 12 from the first side to the second side. Second hose barb 22B is mechanically coupled to blind bore 26. Blind bore 26 is joined to central opening 16 with transverse bore 28.

Oil flows through transmission oil cooler adapter 10 using Bernoulli and Venturi principals. An oil pump pumps the transmission oil into second hose barb 22B which fills blind bore 26 and then travels through transverse bore 28. From there oil descends through central tube 18 and into the transmission oil case. From the transmission oil case, the transmission oil is pumped through longitudinal bore 24 and finally out of first hose barb 22A.

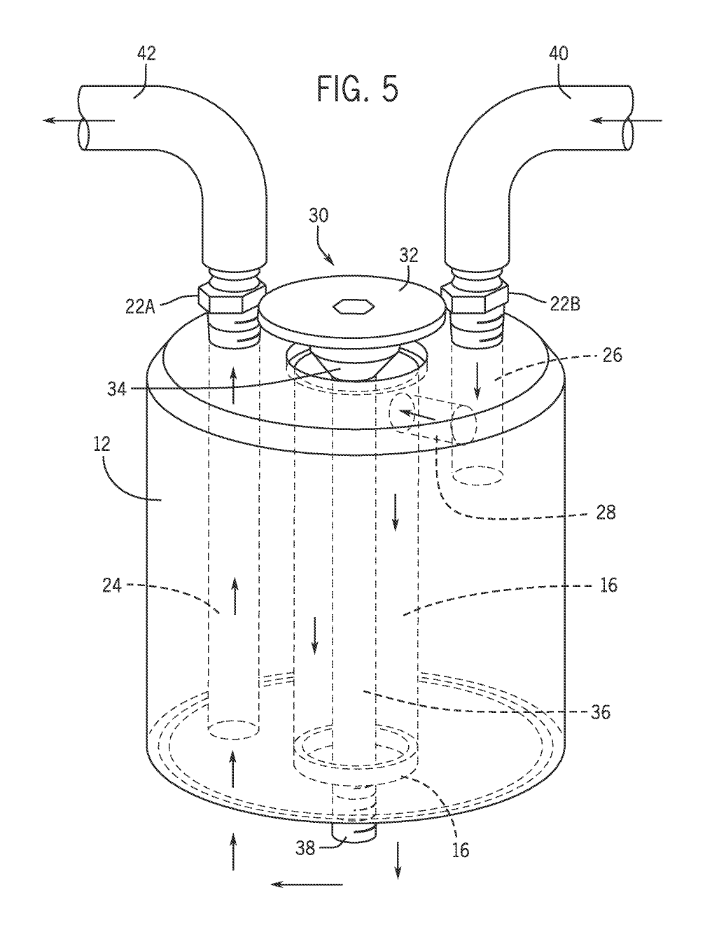

FIG. 5 provides one theory of how to install transmission oil cooler adapter 10 into a transmission case. Bolt 30 comprises bolt head 32 mechanically coupled to transition section 34. Transition section 34 is mechanically coupled to shaft 36. Transition section 34 slopes inward to direct transmission oil downward to the transmission case. Shaft 36 further comprises threaded section 38. Threaded section 38 is configured to mate with equivalent threads in the transmission case. Further, central tube 18, fits down and into the transmission case. Oil coming from the transmission oil cooler travels through transmission oil cooler outlet line 40 and into second hose barb 22B. Oil coming from the transmission case travels through first hose barb 22A and into transmission oil cooler inlet line 42 which then travels to the transmission oil cooler.

For this to be effective, the diameter of transverse bore 28 must be less than blind bore 26. As a matter of experimentation, this is most effective when a first diameter is equal and found throughout blind bore 26. A second diameter is found throughout transverse bore 26. In some embodiments, the first diameter is twice the second diameter. Preferably, the first diameter is three times the second diameter.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A transmission oil cooler adapter configured to mount to a transmission case and direct transmission oil to and from a transmission oil cooler, the transmission oil cooler adapter comprising:
a housing surrounding a body wherein the body further comprises a first side, a second side and a central opening;
a first hose barb and a second hose barb, mechanically coupled to the first side
a longitudinal bore connected to the first hose barb and traveling through the body;
a blind bore connected to the second hose barb connected to the central opening with a transverse bore;
a bolt inserted through the central opening and attaching the housing to the transmission case;
wherein transmission oil travels through the body and into the transmission case then from the transmission case to the transmission oil cooler in order to cool the transmission oil.

2. The transmission oil cooler adapter of claim 1, wherein the central opening is lined with a central tube in order to prevent plastic deformation of the transmission oil cooler adapter undergoing vibration.

3. The transmission oil cooler adapter of claim 1,
a first diameter exists throughout the transverse bore and the blind bore;
a second diameter exists throughout the transverse bore; and
wherein the first diameter is greater than the second diameter.

4. The transmission oil cooler adapter of claim 3, wherein the first diameter is twice the second diameter.

5. The transmission oil cooler adapter of claim 3, wherein the first diameter is three times the second diameter.

6. The transmission oil cooler adapter of claim 1, wherein the bolt further comprises a bolt head configured to cover the central opening on the first side.

7. The transmission oil cooler adapter of claim 6, wherein the bolt further comprises a transition section configured to direct transmission oil toward the transmission case.

8. The transmission oil cooler adapter of claim 7, wherein the bolt further comprises a shaft with a threaded section wherein the threaded section is configured to mate with and attach to the transmission case.
